(19) United States
(12) Patent Application Publication
(10) Pub. No.: US 2013/0262740 A1
(43) Pub. Date: Oct. 3, 2013

(54) SEMICONDUCTOR MEMORY DEVICE, SYSTEMS AND METHODS IMPROVING REFRESH QUALITY FOR WEAK CELL

(71) Applicant: SAMSUNG ELECTRONICS CO., LTD., Suwon-si (KR)

(72) Inventors: JungSik Kim, Seoul (KR); Jungbae Lee, Seongnam-si (KR)

(73) Assignee: Samsung Electronics Co., Ltd., Suwon-si (KR)

(21) Appl. No.: 13/802,748

(22) Filed: Mar. 14, 2013

(30) Foreign Application Priority Data
Mar. 30, 2012 (KR) 10-2012-0033575

(51) Int. Cl. G06F 12/02

(52) U.S. Cl. CPC G06F 12/0246
USPC 711/102

(57) ABSTRACT

Disclosed is a semiconductor memory device which includes a normal memory cell array; a redundancy memory cell array; and a multi-row selection circuit configured to activate a defective normal memory cell or a defective normal word line of the normal memory cell array while activating a redundancy memory cell or a redundancy word line of the redundancy memory cell array.

### CROSS-REFERENCE TO RELATED APPLICATIONS

This Application claims priority under 35 U.S.C. §119 to Korean Patent Application No. 10-2012-0033575 filed Mar. 30, 2012, in the Korean Intellectual Property Office, the entire contents of which are hereby incorporated by reference.

### BACKGROUND

The inventive concepts described herein relate to a semiconductor memory device, and more particularly, relate to a volatile semiconductor memory device capable of improving a refresh property of a weak cell.

Volatile memory, such as dynamic random access memory (hereinafter, referred to as a DRAM), is widely used as a main memory of a data processing device such as a personal computer, notebook computer, personal data assistant, mobile computing devices such as smart phones, etc.

In DRAM, redundancy memory cells may be designed and fabricated to repair defective memory cells. When a normal memory cell in a normal memory cell array is determined to be defective, it may be replaced with a redundancy memory cell in a redundancy memory cell array. In the redundancy scheme, repair may be performed, for example, on a per word line basis, a per bit line basis, a per block unit basis, or a combination thereof. That is, after detecting a defective cell, the repair operation may replace the word line containing the defective cell with a redundant word line, or the bit line containing the defective cell with a redundant bit line, or a block containing the defective cell with a redundant block, or a combination thereof. Such replacement may occur by modifying a memory location to be accessed in response to a memory address.

A defective state of a normal memory cell may be classified as a hard fail or a soft fail according to a test result of a DRAM chip. A hard failed normal memory cell may require replacement with a redundancy memory cell. However, a soft failed normal memory cell may still be used in certain circumstances, although operations involving soft failed normal memory cells may not be exactly the same as a non-defective normal memory cell.

A soft-failed normal memory cell (which may be a weak cell) may be used as a normal memory cell without replacing the soft failed cell with a redundant memory cell. In this case, the reliability and/or speed of the DRAM chip may be lowered in operation. On the other hand, when a soft failed cell, such as a weak cell, is replaced with a redundant cell, the number of replaced memory cells may increase, thus lowering the repair efficiency and the fabrication yield.

### SUMMARY

Exemplary embodiments include a semiconductor memory device, comprising a normal memory cell array; a redundancy memory cell array; and a redundant word line selection circuit configured to replace a first normal memory cell of the normal memory cell array with a first redundant memory cell of the redundancy memory cell array such that receipt of an address to access the first normal memory cell accesses the first redundant memory cell without access of the first normal memory cell, and configured to supplement a second normal memory cell of the normal memory cell array with a second redundant memory cell of the redundancy memory cell array such that receipt of an address to access the second normal memory cell accesses both the second normal memory cell and the second redundant memory cell.

The second normal memory cell may be operable.

The second normal memory cell may be a weak memory cell requiring a refresh rate higher than normal memory cells of the normal memory cell array that are not weak memory cells.

The second normal memory cell and the second redundant memory cell may be connected to operate as a twin cell.

The first normal memory cell may be connected to a first normal word line of the normal memory cell array, the redundant memory cell may be connected to a first redundant word line of the redundancy memory cell array, second normal memory cell may be connected to a second normal word line of the normal memory cell array, and the second redundant memory cell is may be connected to a second redundant word line of the redundancy memory cell array.

The second normal word line and the second redundant word line may be connected as a twin word line.

The semiconductor memory device may comprise a normal word line selection circuit configured to not activate an addressed normal word line of the normal memory cell array in response to a normal word line blocking signal having a first logic state; and a redundancy word line selection circuit configured to transmit the first logic state of the normal word line blocking signal to the normal word line selection circuit in response to identifying the addressed normal word line as a hard fail defective word line, and configured to not transmit the first logic state of the normal word line blocking signal in response to identifying the addressed normal word line as a soft fail word line.

Exemplary device may comprise a memory cell array including a plurality of memory blocks each having a plurality of normal memory cells connected with a plurality of normal word lines and a plurality of redundant memory cells connected with a plurality of redundant word lines; and a multi-row selection circuit configured to, in response to a first address, simultaneously activate both a first defective normal word line in a first memory block and a first redundant word line in the first memory block, memory cells of the first defective normal word line and the first redundant word line being paired as twin memory cells, wherein the first defective normal word line is connected to one or more weak memory cells.

Normal memory cells of the memory cell array that are not weak memory cells may be characterized by an ability to retain data for a longer period of time than the one or more weak memory cells.

The multi-row selection circuit may be configured to, in response to a second address, activate a second defective redundant word line and prevent activation of a second normal word line identified by the second address.

The first defective normal word line and the first redundant word line form a twin word line may have a longer minimum refresh interval than a minimum refresh interval of the first defective normal word line.

The first defective normal word line and the first redundant word line may function as a twin word line having an improved memory operation property as compared to the first defect normal word line.

The multi-row selection circuit may comprise a normal word line selection circuit configured to not activate an addressed normal word line of the normal memory cell array in response to a normal word line blocking signal having a first logic state; and a redundancy word line selection circuit configured to transmit the first logic state of the normal word line blocking signal to the normal word line selection circuit in response to identifying the addressed normal word line as a hard fail defective word line, and configured to not transmit the first logic state of the normal word line blocking signal in response to identifying the addressed normal word line as a soft fail word line.

The normal word line selection circuit may comprise a normal row decoder configured to decode a row address to generate a decoded row address; and a normal word line driver configured to drive a selected normal word line in response to the decoded row address and the normal word line blocking signal.

The redundancy word line selection circuit may comprise a fuse program circuit configured to store addresses associated with hard failed and soft failed normal memory cells or normal word lines and to output a redundancy signal when an input address is equal to one of the stored addresses; a blocking selection part configured to transmit the normal word line blocking signal in response to the redundancy signal and to not transmit the normal word line block signal when an address indicating a soft failed normal word line or normal word line is received; and a redundancy word line driver configured to drive a redundancy word line in response to the redundancy signal.

The defective normal memory cell and the redundancy memory cell may form a twin cell connected with a bit line and a complementary bit line.

Methods of manufacturing may comprise testing a semiconductor memory device to determine defective memory cells; programming the semiconductor memory device to replace one or more first defective normal memory cells with one or more first redundant memory cells such that addressing the one or more first defective normal memory cells for access results in accessing the first redundant memory cells; and programming the semiconductor memory device to supplement one or more second normal memory cells with one or more second redundant memory cells such that addressing the one or more second normal memory cells for access results in simultaneously accessing the one or more second normal memory cells and the one or more second redundant memory cells.

The methods may comprise testing the semiconductor memory device to determine weak memory cells of the semiconductor memory device; wherein the second normal memory cells are weak memory cells a determined by the testing step.

The methods may comprise determining weak memory cells as memory cells requiring a refresh rate higher than a predetermined value.

The one or more first defective normal memory cells may be connected to a first normal word line, the first one or more redundant memory cells may be connected to a first redundant word line, the one or more second normal memory cells may be connected to a second normal word line, the one or more second redundant memory cells may be connected to a second redundant word line, and the first normal word line and the first redundant word line may be connected to the same bit lines.

The first normal word line, the first redundant word line, the second normal word line and the second redundant word line may be connected to the same bit lines.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a semiconductor memory device according to an embodiment of the inventive concept.

FIG. 2 is a detailed block diagram illustrating exemplary details of circuit blocks in FIG. 1.

FIG. 3 is a block diagram schematically illustrating a semiconductor memory device according to another embodiment of the inventive concept.

FIG. 4 is a diagram illustrating a multi-word line driving manner according to an embodiment of the inventive concept.

FIG. 5 is a diagram illustrating a multi-word line driving manner according to another embodiment of the inventive concept.

FIG. 6 is a circuit diagram illustrating an exemplary redundancy word line driver in FIG. 2.

FIG. 7 is a circuit diagram illustrating an exemplary blocking selection part in FIG. 2.

FIG. 8 is a circuit diagram illustrating an exemplary normal word line driver in FIG. 2.

FIG. 9 is a block diagram illustrating a memory system.

FIG. 10 is a block diagram illustrating an electronic device.

FIG. 11 is a block diagram illustrating a system implementing an optical I/O scheme.

FIG. 12 is a block diagram illustrating a system using a through silicon via (TSV) structure.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. These example embodiments are just that—examples—and many implementations and variations are possible that do not require the details provided herein. Accordingly, known processes, elements, and techniques may not be described with respect to some of the embodiments of the inventive concept. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

In the disclosure, connections between any elements, such as lines in figures or described communications in the specification, may include both direct connections and indirect connections.

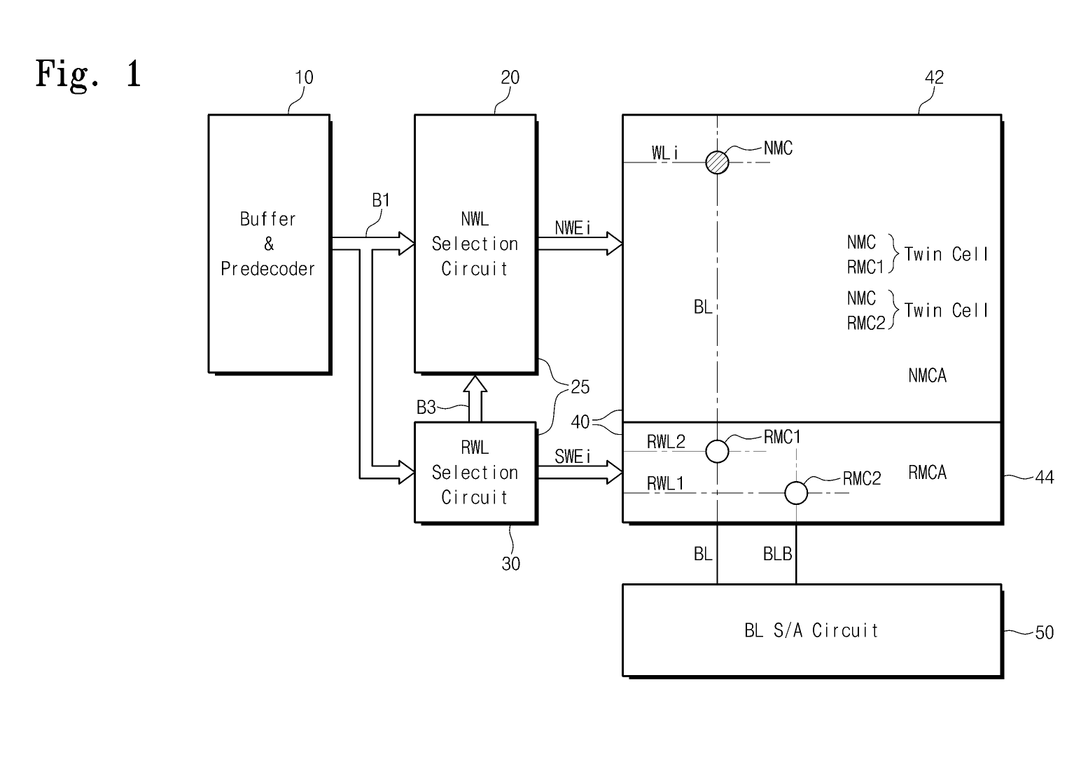

FIG. 1 is a block diagram schematically illustrating a semiconductor memory device according to an embodiment of the inventive concept.

Referring to FIG. 1, a semiconductor memory device may include a buffer and pre-decoder 10, a normal word line selection circuit 20, a redundancy word line selection circuit 30, a memory cell array 40, and a bit line sense/amplifier circuit 50.

The buffer and pre-decoder 10 may buffer and pre-decode a row address. The pre-decoded row address may be transferred to a multi-row selection part 25 via a bus line B1.

The normal word line selection circuit 20 and the redundancy word line selection circuit 30 may constitute the multi-row selection part 25.

The normal word line selection circuit 20 may activate or prevent or determine not to activate a normal word line enable signal NWEi. The normal word line selection circuit 20 may stop activation of a normal word line of a normal memory cell array 42 that otherwise would have been activated in response to a normal word line blocking signal. The normal word line blocking signal may be applied when a defective normal memory cell or a defective word line is is determined to be a hard failed memory cell. The determination that the memory cell is hard failed may be made during testing of the semiconductor memory device during manufacturing of the semiconductor memory device. The semiconductor memory device may be programmed (e.g., by a fuse bank) to identify the hard failed defective memory cells (such as programming addresses of a word line, a bit line, a block or other location containing a hard failed defective memory cell). For ease of description, the embodiments herein relate to word line redundancy (e.g., replacing word lines with hard failed memory cells with a redundant word line), but as noted, other replacement/repair units (bit lines, blocks, etc.) may be used other than word lines.

The redundancy word line selection circuit 30 may activate or leave inactive a redundancy word line enable signal SWEi. When a defective normal memory cell or a defective word line is identified as a soft failed cell or word line (e.g., during testing and programmed in the semiconductor memory device as a soft failed cell or word line), the redundancy word line selection circuit 30 may disable or not activate the normal word line blocking signal, and may activate a redundancy word line RWL of a redundancy memory cell array 44. When a defective normal memory cell or a defective word line is identified as a hard failed cell or word line (e.g., during testing and programmed in the semiconductor memory device as a hard failed cell or word line), the redundancy word line selection circuit 30 activate the normal word line blocking signal and may activate a redundancy word line RWL of a redundancy memory cell array 44.

The memory cell array 40 may include the normal memory cell array 42 and the redundancy memory cell array 44. The normal memory cell array 42 may include a plurality of normal memory cells. The redundancy memory cell array 44 may include a plurality of redundancy memory cells.

Each of a redundant memory cell and a normal memory cell may be formed of an access transistor and a storage capacitor. A gate of the access transistor may be connected to a word line (e.g., a row), and a drain or source thereof may be connected to a bit line (which may be formed in a column direction).

A plurality of word lines and a plurality of bit lines may be arranged in a matrix and intersect each other (from a top down perspective). Each memory cell may be placed at an intersection of a word line and a bit line. Herein, a word line connected with a normal memory cell NMC may be referred to as a normal word line WLi, and a word line connected with a redundancy memory cell RMC may be referred to as a redundancy word line RWL.

In the event that a normal memory cell NMC of the normal memory cell array 42 is judged to be soft failed (or, treated as a defective normal memory cell), the multi-row selection part 25 may simultaneously activate a normal word line WLi connected with a defective normal memory cell NMC of the normal memory cell array 42 and a redundancy word line RWL2 connected with a redundancy memory cell RMC1 of the redundancy memory cell array 44. At this time, the defective normal memory cell NMC and the redundancy memory cell RMC1 may form a twin cell storing the same data, such as the same single-bit data.

In the DRAM, an access transistor and a storage capacitor often constitute a single cell. In this embodiment, a twin cell may be formed of two single cells—that is, a pair of access transistor/capacitor combinations, each access transistor being activated by a corresponding word line to allow access to its associated capacitor. Thus, compared with a single cell structure, the twin cell structure may enable a refresh time interval of a memory cell to be larger, so that refresh operations to restore data are improved. With the twin cell structure, a cell data rewrite period, that is, a refresh period may be made longer, thus reducing a standby current.

In example embodiments, a defective normal memory cell and a redundancy memory cell may form and operate as a twin cell, without replacing a soft-failed defective normal memory cell with a redundancy memory cell.

In FIG. 1, a defective normal memory cell NMC may form a twin cell with a redundancy memory cell RMC1 connected with a redundancy word line RWL2 through a selection operation of the redundancy word line selection circuit 30. The defective normal memory cell NMC and the redundancy word line RWL2 may constitute a twin cell sharing a bit line BL.

Through a selection operation of the redundancy word line selection circuit 30, the defective normal memory cell NMC may form a twin cell with a redundancy memory cell RMC2 connected with a redundancy word line RWL1. In this case, the defective normal memory cell NMC and the redundancy memory cell RMC2 may constitute a twin cell connected with a bit line BL and a complementary bit line BLB, respectively.

In FIG. 1, the normal memory cell array 42 and the redundancy memory cell array 44 may be included within the same memory block or memory bank.

A weak cell NMC of the normal memory cell array 42 may form a twin cell together with a redundancy memory cell RMC1 or RMC2 of the redundancy memory cell array 44 placed at the same memory block or memory bank. Cells of the twin cell may operate (e.g., be accessed and sensed) at the same time. For example, a normal word line NWEi and a spare word line SWEi may both be activated at the same time to allow access to capacitors of individual memory cells connected to the activated normal word line NWEi and spare word line SWEi. Bit lines may be shared between the memory cells of the activated normal word line NWEi and the activated spare word line SWEi, allowing writing of the same data to the memory cells constituting a twin cell, reading of the same data of the memory cells constituting a twin cell and/or refreshing the same data of the memory cells constituting a twin cell. It is noted that plural twin cells may be formed in this instance for each of the bit lines connecting a normal memory cell NMC of the normal word line NWEi and a redundant memory cell RMC of the spare word line SWEi. Thus, the refresh property of a weak cell may be improved and may operate reliably, which may be have the same or better data retention properties (e.g., same or better data retention time) as a non-defective normal memory cell.

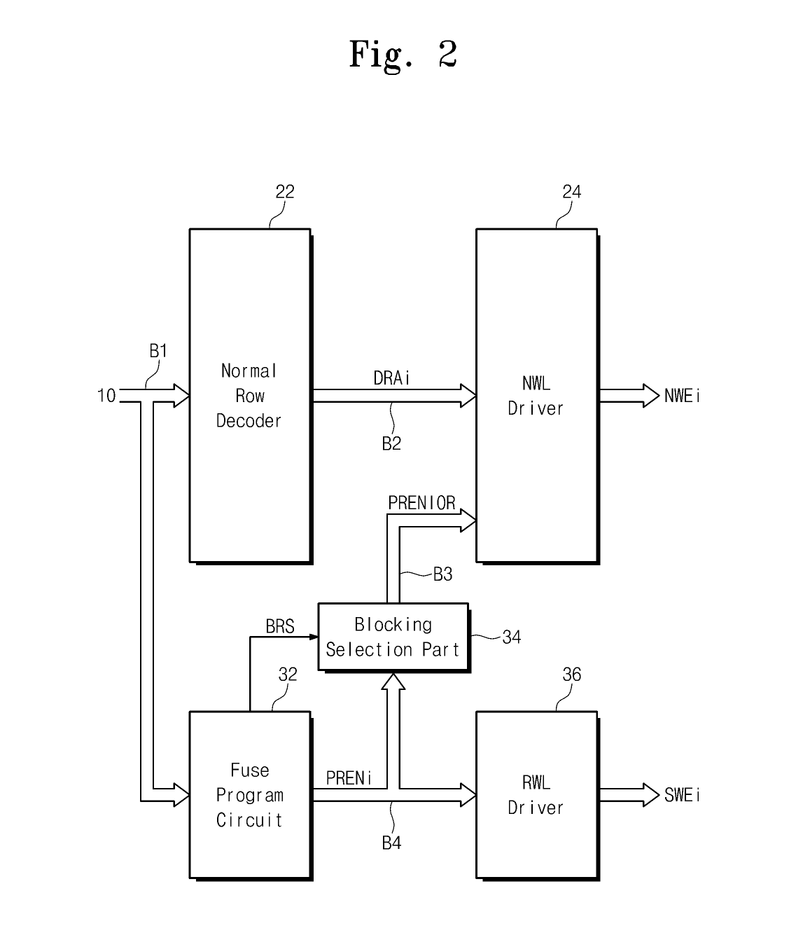

FIG. 2 is a detailed block diagram illustrating exemplary details of circuit blocks in FIG. 1.

Referring to FIG. 2, a normal word line selection circuit 20 in a multi-row selection part 25 of FIG. 1 may include a normal row decoder 22 and a normal word line driver 24.

A redundancy word line selection circuit 30 of the multi-row selection part 25 may include a fuse program circuit 32, a redundancy word line driver 36, and a blocking selection part 34.

The normal row decoder 22 may decode a row address (or, a pre-decoded row address) to generate a decoded row address DRAi on a bus line B2.

The normal word line driver 24 may drive a selected normal word line NWEi in response to the decoded-row address DRAi and a normal word line block signal PRENIOR.

The fuse program circuit 32 may store addresses of hard-failed and soft-failed normal memory cells or hard-failed and soft-failed normal word lines, and may output a redundancy signal PRENi on a bus line B4 when the same address as stored therein is received. For example, the fuse program circuit 32 may include a n (n being an integer) programmable registers storing row addresses of defective (soft-failed or hard-failed) word lines and n comparators, comparing the stored row addresses with the received row address of the word line attempting to be accessed. Upon detecting a match between the address stored in the corresponding programmable register address and the received address, the corresponding comparator may output a redundancy signal PRENi. Each of the programmable registers may constitute a set of fuses (that may be programmed during manufacturing, e.g.) The fuse program circuit 32 may output a blocking release signal BRS to the blocking selection part 34 when an input address is equal to an address of a soft-failed normal memory cell or a soft failed normal word line. For example, each of the programmable registers may further include a flag fuse that indicates whether the stored address corresponds to a hard failed word line or corresponds to a soft failed word line. When the flag fuse indicates the address corresponds to a soft failed word line and the comparator indicates a match, BRS may be generated as a high logic level (e.g., by ORing soft-failed matching signals output by corresponding comparators). The fuse program circuit 32 may include fuse banks of fuses that are cut by a laser or are electrically fusible to program address information. A defective address of a normal memory cell may be programmed by cutting or connecting fuses (depending on the type of fuse).

In example embodiments, a blocking release signal BRS having a high level may be output when an input address is equal to an address of a soft-failed normal memory cell or normal word line. A blocking release signal BRS having a low level may be output when an input address is equal to an address of a hard-failed normal memory cell or normal word line.

The blocking selection part 34 may receive the redundancy signal PRENi to generate the normal word line blocking signal PRENIOR on a bus line B3 to prevent enabling of the activation (e.g., driving) of a normal word line (e.g., prevent enabling the activation of the normal word line identified by address DRAi). The normal word line blocking signal PRENIOR may be disabled or otherwise not sent when an address for selecting a soft-failed normal memory cell or normal word line is received to thereby allow activation of a normal word line (e.g., that word line identified by address DRAi). When the fuse program circuit 32 receives an input address equal to an address of a hard failed normal word line, blocking selection part 34 may receive the redundancy signal PRENi and generate the normal word line blocking signal PRENIOR on a bus line B3 to prevent enabling of the activation (e.g., driving) of the hard failed normal word line NWL. The redundancy word line driver 36 may drive a redundancy word line SWEi corresponding to the redundancy signal PRENi.

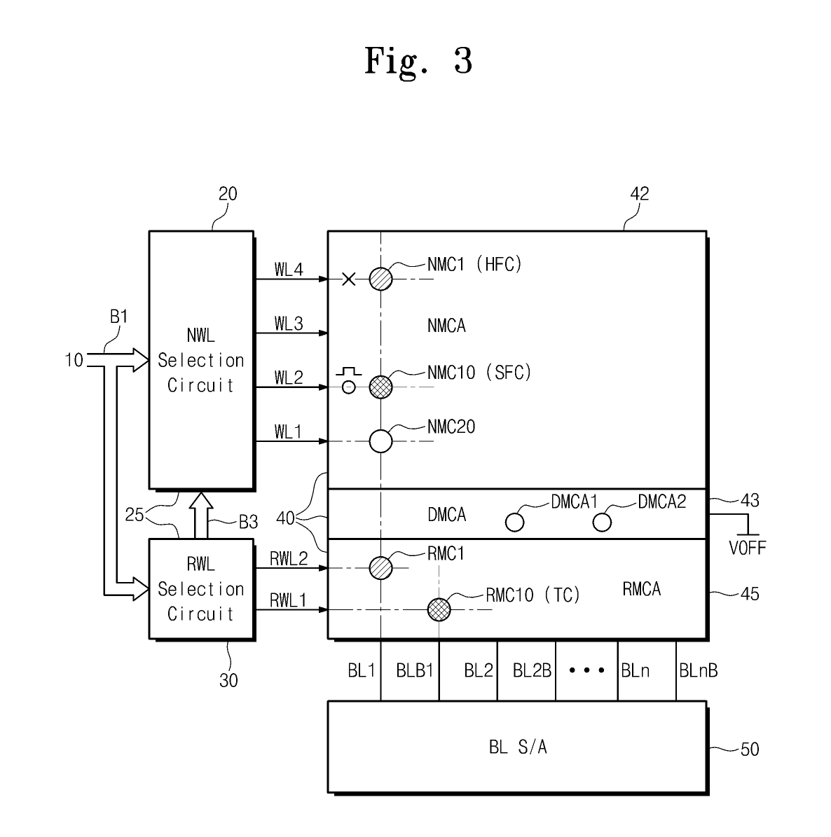

FIG. 3 is a block diagram schematically illustrating a semiconductor memory device according to another embodiment of the inventive concept.

Referring to FIG. 3, a semiconductor memory device may include a normal word line selection circuit 20, a redundancy word line selection circuit 30, a memory cell array 42, and a bit line sense/amplifier circuit 50.

A pre-decoded row address may be provided to a multi-row selection part 25 through a bus line Bl.

The normal word line selection circuit 20 and the redundancy word line selection circuit 30 may constitute the multi-row selection part 25.

The normal word line selection circuit 20 may activate or inactivate normal word line enable signals WL1 to WL4. The normal word line selection circuit 20 may inactivate a normal word line of a normal memory cell array 42 in response to a normal word line blocking signal which is applied through a bus line B3 when a defective normal memory cell or a defective word line is programmed as hard fail (or, judged to be hard failed).

The redundancy word line selection circuit 30 may activate or inactivate redundancy word line enable signals RWL1 and RWL2. The redundancy word line selection circuit 30 may disable a normal word line blocking signal when a defective normal memory cell or a defective word line is programmed as soft fail (or, judged to be soft failed), and may activate a redundancy word line RWL1 of the redundancy memory cell array 45.

The memory cell array 40 may include the normal memory cell array 42, a dummy memory cell array 43, and the redundancy memory cell array 45. The normal memory cell array 42 may include a plurality of normal memory cells NMC. The redundancy memory cell array 45 may include a plurality of redundancy memory cells RMC. The dummy memory cell array 43 may include a plurality of dummy memory cells DMC. In example embodiments, dummy memory cells DMC of the dummy memory cell array 43 may not form a twin cell with a normal memory cell NMC. That is, a dummy word line of a dummy memory cell may be configured to receive an off voltage VOFF (e.g., a ground or reference voltage), and may not otherwise participate in a memory operation.

In the event that a normal memory cell NMC1 of the normal memory cell array 42 is judged to be hard failed (or, treated as a perfectly defective normal memory cell), the multi-row selection part 25 may not activate a defective normal word line WL4 connected with the hard failed defective normal memory cell in the normal memory cell array 42. At this time, the multi-row selection part 25 may activate a redundancy word line RWL2 connected with a redundancy memory cell RMC1 in the redundancy memory cell array 45. Thus, the defective normal memory cell NMC1 may be replaced with the redundancy memory cell RMC1.

In the event that a normal memory cell NMC1 of the normal memory cell array 42 is judged to be soft failed (or, treated as a defective normal memory cell), the multi-row selection part 25 may activate both a defective normal word line WL2 connected with the defective normal memory cell NMC10 in the normal memory cell array 42 and a redundancy word line RWL1 connected with a redundancy memory cell RMC10 in the redundancy memory cell array 45. In this case, the defective normal memory cell NMC10 and the redundancy memory cell RMC10 may act as a twin cell storing the same data, such as the same single-bit data.

With the above description, it is possible to improve a refresh property of a memory cell. Also, a standby current may be reduced in accordance with an increase in a refresh period.

In FIG. 3, a dummy memory cell in the dummy memory cell array 43 may not form a twin cell structure with a defective normal memory cell. Also, a defective normal memory cell may act as a twin cell with a redundancy memory cell without replacing a soft-failed normal memory cell with a redundancy memory cell. Also, a defective normal memory cell may fully replace a defective normal memory cell (without forming a twin cell) when the defective normal memory cell is determined to be a hard failed memory cell.

With a selection operation of the redundancy word line selection circuit 30, a defective normal memory cell NMC10 may form a twin cell with a redundancy memory cell RMC10 connected with a redundancy word line RWL1. In this case, the defective normal memory cell NMC10 and the redundancy memory cell RMC10 may form a twin cell connected with a bit line BL and a complementary bit line BLB.

In FIG. 3, the normal memory cell array 42 and the redundancy memory cell array 45 may be included within different memory blocks or memory banks.

As understood from the above description, a weak cell NMC in a normal memory cell array may form a twin cell together with a redundancy memory cell in a redundancy memory cell array placed within a memory block or memory bank different from that of the weak cell NMC, so as to operate (e.g., accessed for a write, read or refresh operation) at the same time. The normal memory cell and redundancy memory cell forming the twin cell may be connected and operate with the same bit line or same bit line pair. For example, when a specific memory block or memory bank does not have a redundancy memory cell array or all memory of a redundancy memory cell array has been previously used for repairing, a defective normal memory cell in the specific memory block or memory bank may form a twin cell together with a redundancy memory cell in a redundancy memory cell array placed within a memory block or memory bank different from that of the defective normal memory cell. Alternatively or in addition, when redundancy memory of the redundancy memory cell array has been used up (e.g, such as by supplementing other weak cell NMC in the normal memory cell array in the same memory block or same memory bank to form twin cells, as described herein), the weak cell NMC may be treated similar to a hard fail cell in a normal memory cell and replaced by a redundancy memory cell within a within a memory block or memory bank different from that of the defective normal memory cell such that selection of this weak cell NMC acts to activate the replacement redundancy memory cell only and not this weak cell NMC.

Likewise, since a refresh property of a weak cell is improved by a redundancy memory cell, the weak cell may operate reliably like a non-defective normal memory cell.

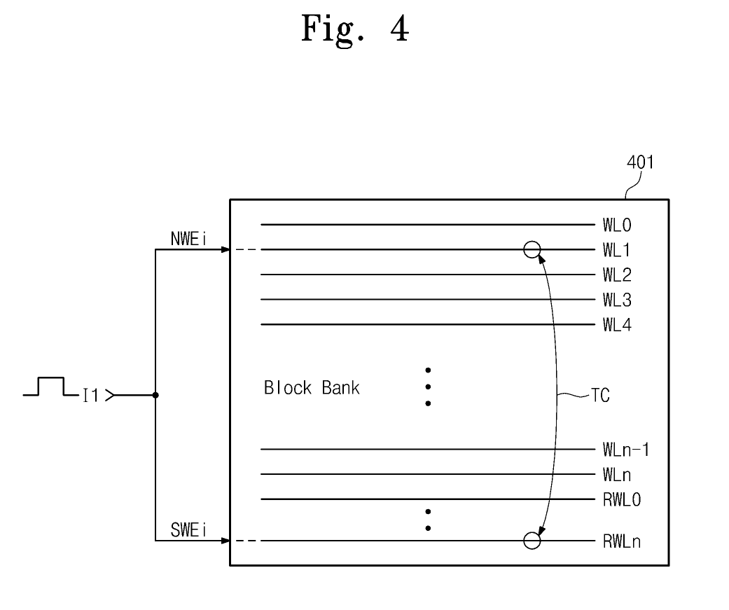

FIG. 4 is a diagram illustrating a multi-word line driving manner according to an embodiment of the inventive concept.

Referring to FIG. 4, 401 may indicate a memory block or a memory bank. The block 401 may include a plurality of normal word lines WL0 to WLn and a plurality of redundancy word lines RWL0 to RWLn. The plurality of normal word lines WL0 to WLn may be connected with normal memory cells, and the plurality of redundancy word lines RWL0 to RWLn may be connected with redundancy memory cells.

It is assumed that a normal memory cell or normal memory cells connected with a normal word line WL1 are judged to be soft failed.

A high-pulse input signal I1 may be applied to the normal word line WL1 and a redundancy word line RWLn connected with a redundancy memory cell. That is, when a row address indicating the normal word line WL1 is received, the normal word line WL1 may be activated with the redundancy word line RWLn in the block 401. Thus, two word lines WL1 and RWLn may be enabled at the same time. Each of plural bit lines may be connected to access a memory cell of the normal word line WL1 and the redundancy word line RWLn at the same time. When a bit line connected with a defective normal memory cell is selected according to an input of a column address, a defective normal memory cell connected with the normal word line WL1 and a redundancy memory cell connected with the redundancy word line RWLn may both be accessed (e.g., access transistors of these memory cells may be on to allow access to corresponding capacitors connected to each access transistor). The defective normal memory cell connected with the normal word line WL1 and the redundancy memory cell connected with the redundancy word line RWLn may form a twin cell.

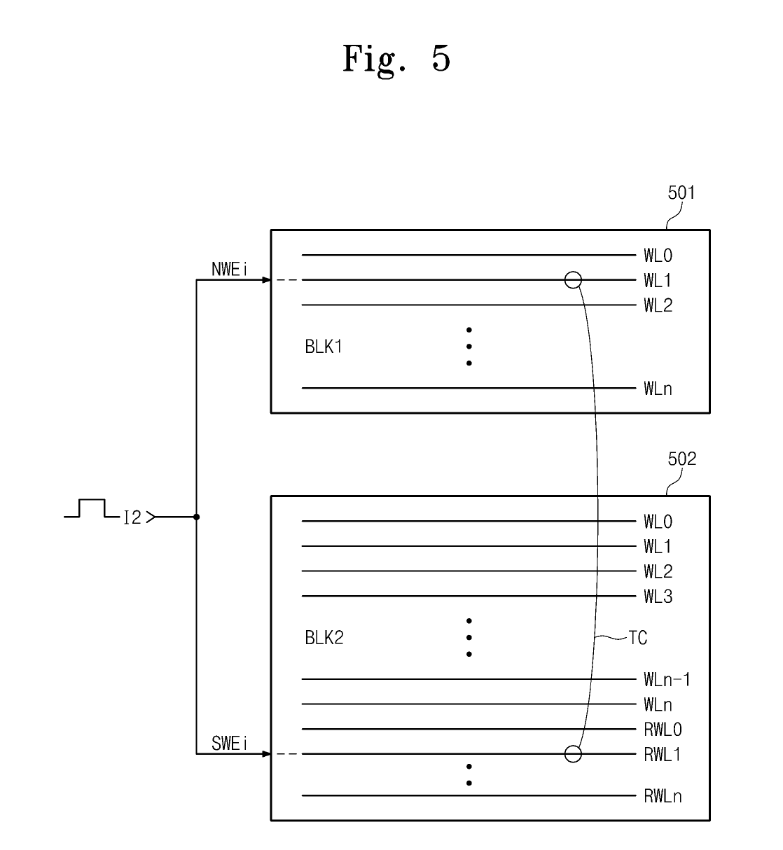

FIG. 5 is a diagram illustrating a multi-word line driving manner according to another embodiment of the inventive concept.

Referring to FIGS. 5, 501 and 502 may indicate a memory block or a memory bank, respectively. That is, a block 501 may be different from a block 502. The blocks 501 and 502 may be adjacent. Alternatively, another block of memory cells can be interposed between the blocks 501 and 502. Each block of memory cells may be formed of a continuous set of rows of memory cells in the column direction without other intervening circuitry, or without peripheral circuitry.

The block 501 may not include a redundancy word line connected with redundancy memory cells. On the other hand, the block 502 may include a plurality of normal word lines WL0 to WLn and a plurality of redundancy word lines RWL0 to RWLn. The plurality of normal word lines WL0 to WLn may be connected with normal memory cells, and the plurality of redundancy word lines RWL0 to RWLn may be connected with redundancy memory cells.

It is assumed that a normal memory cell or normal memory cells connected with a normal word line WL1 are judged to be soft failed.

A high-pulse input signal 12 may be applied to the normal word line WL1 in the block 501 and a redundancy word line RWL1 in the block 502 connected with a redundancy memory cell. That is, when a row address indicating the normal word line WL1 is received, the normal word line WL1 may be activated with the redundancy word line RWL1 in the block 502. Thus, two word lines WL1 and RWL1 may be enabled at the same time. When a bit line connected with a defective normal memory cell is selected according to an input of a column address, a defective normal memory cell connected with the normal word line WL1 may form a twin cell TC with a redundancy memory cell connected with the redundancy word line RWL1 in the block 502 different from the block 501.

FIG. 6 is a circuit diagram illustrating an exemplary redundancy word line driver of FIG. 2.

Referring to FIG. 6, a redundancy word line driver 36 may include two PMOS transistors PM1 and PM2, an inverter I1, a fuse F1, and an NMOS transistor NM1.

A signal PXP may be applied to a gate of the PMOS transistor PM1. The signal PXP may be a signal for pre-charging a row decoder, and may be generated from a general PXP generator. A redundancy signal PRENi may be applied to a gate of the NMOS transistor NM1. The redundancy signal PRENi may have a high level when a redundancy word line is activated. In the event that the fuse F1 is not cut or blown, the NMOS transistor NM1 may be turned on, so that a potential of a node ND1 decreases toward a ground level. At this time, an input of the inverter I1 may goes to a low level, so that a redundancy word line SWEi has a high level. Thus, a corresponding redundancy word line may be enabled. The redundancy signal PRENi may go to a low level when a redundancy word line is inactivated. A potential of the node ND1 may go to a high level through a turned-on PMOS transistor PM1. Thus, an output of the inverter I1, that is, the redundancy word line SWEi may have a low level.

In example embodiments, a redundancy word line may be activated when a normal memory cell is hard failed or soft failed.

The fuse F1 may be cut or blown to replace a defective redundancy word line with another redundancy word line.

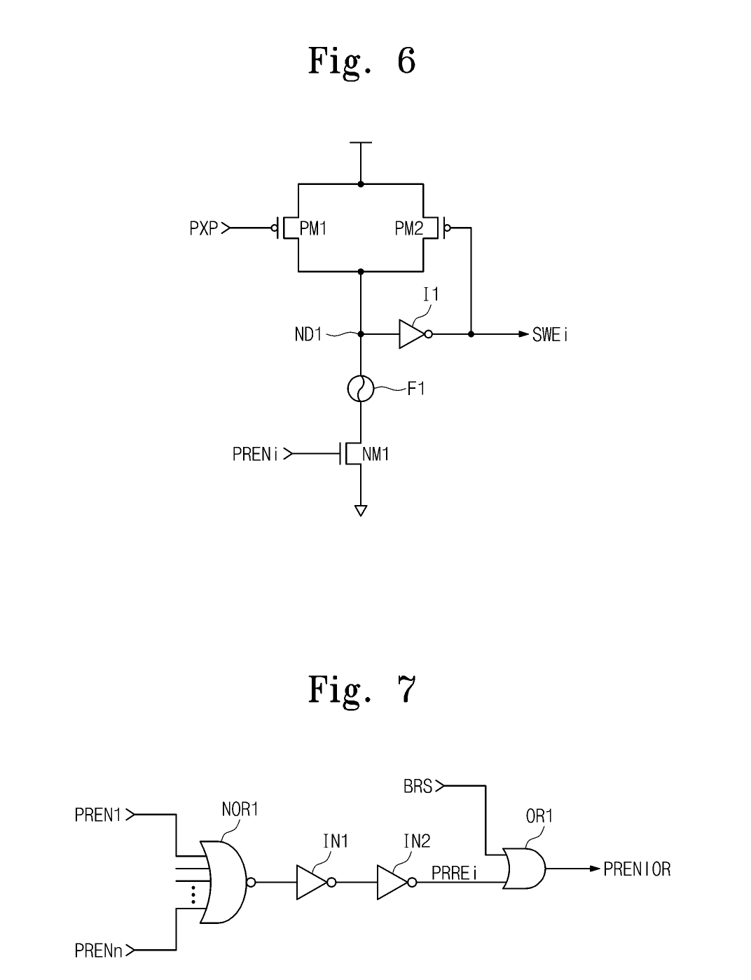

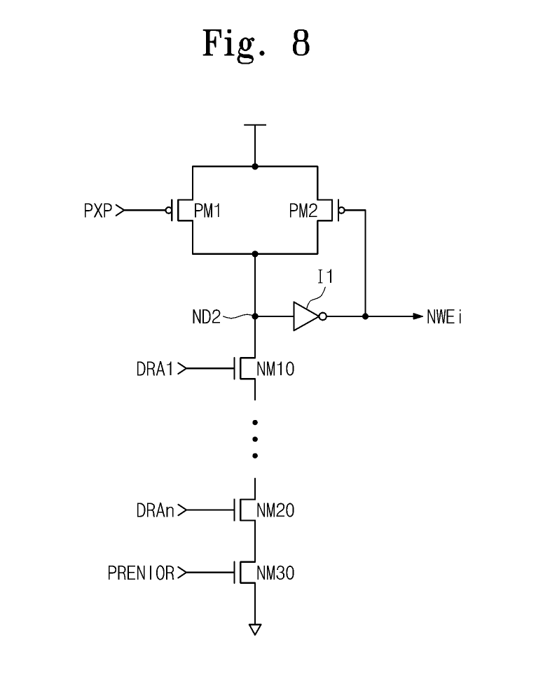

FIG. 7 is a circuit diagram illustrating an exemplary blocking selection part in FIG. 2.

Referring to FIG. 7, a blocking selection part may be a circuit that includes a NOR gate NOR1, two inverters IN1 and IN2, and an OR gate OR1.

The NOR gate NOR1 may receive redundancy signals PREN1 to PRENn (n being a natural number more than 1) to generate a normal blocking signal PRREi. That is, the NOR gate NOR1 may receive the redundancy signals PREN1 to PRENn from a fuse program circuit 32. When at least one of the redundancy signals PREN1 to PRENn has a high level, the NOR gate NOR1 may output a low-level signal. Thus, the normal blocking signal PRREi output from the inverter IN2 may have a low level. When the normal blocking signal PRREi is low, indicating an initial decision to block activation of a normal word line, and the blocking release signal BRS is not activated (having a logic low in this example), the normal blocking signal PRREi has a low level to block activation of a normal word line. The OR gate OR1 may output a normal word line blocking signal PRENIOR by ORing a blocking release signal BRS and the normal block signal PRREi. When a normal word line connected with a defective normal memory cell should be driven at soft fail, the blocking release signal BRS may have a high level. Thus, although the normal blocking signal PRREi has a low level, the normal word line blocking signal PRENIOR may go to a high level. The high level of normal word line blocking signal PRENIOR may allow the normal word line to be activated. That is, a defective normal word line and a redundancy word line may be activated at the same time.

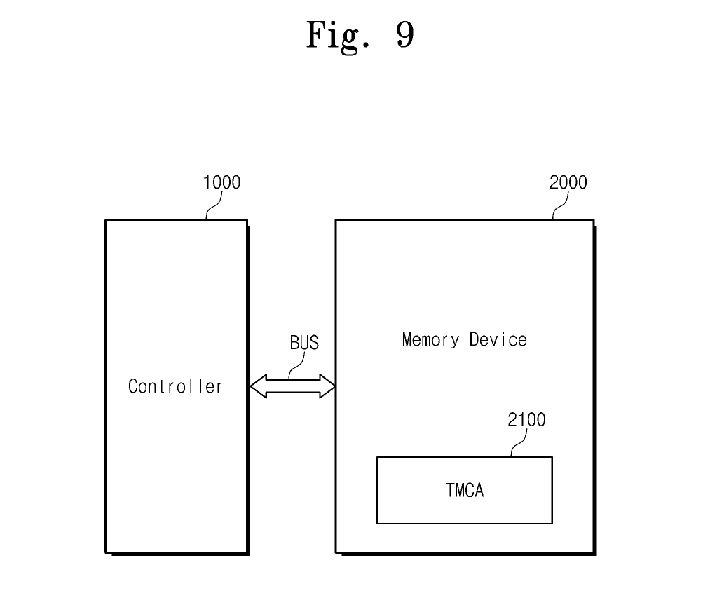

FIG. 8 is a circuit diagram illustrating an exemplary normal word line driver of FIG. 2.

Referring to FIG. 8, a normal word line driver 24 may include two PMOS transistors PM1 and PM2, an inverter I1, and a plurality of NMOS transistors NM10 to NM30.

Decoded row address signals DRA1 to DRAn may be applied to gates of the NMOS transistors NM10 to NM20, respectively.

When a normal word line blocking signal PRENIOR is at a high level, a normal word line NWEi corresponding to the decoded row address may be activated. When a normal word line blocking signal PRENIOR is at a low level, the NMOS transistor NM30 may be turned off. Thus, a normal word line NWEi corresponding to the decoded row address may be inactivated.

A potential of a node ND2 may go to a low level when the decoded row address selecting the normal word line NWEi is received and the normal word line blocking signal PRENIOR is at a high level. Since a level inverted by the inverter I1 may become a high level, the normal word line NWEi may be enabled.

As described above, the repair efficiency and yield may be improved by operating a weak cell and a redundancy memory cell as a twin cell without replacing the weak cell.

FIG. 9 is a block diagram illustrating a memory system to which the inventive concept is applied.

Referring to FIG. 9, a memory system may include a controller 1000 and a memory device 2000. The memory device 2000 may be configured such that a twin memory cell array 2100 including twin cells according to an embodiment of the inventive concept is provided within a memory cell array. The controller 1000 may provide command signals, address signals, and data to the memory device 2000 through a bus. The memory device 2000 may decode the command signals to perform a refresh operation for keeping data stored at memory cells. A normal memory cell or normal memory cells judged to be soft failed during testing of the semiconductor memory device may not be replaced with a redundancy memory cell or redundancy memory cells. Instead, a soft failed cell having a defect such as a weak cell may be configured to be operated as a twin cell with a redundancy memory cell. Since the repair efficiency and yield are improved, a fabrication cost of the memory system may be lowered.

In some embodiments, during testing of the semiconductor memory device, hard failed word lines (or hard failed memory cells, bit lines, memory cell blocks, etc.) are identified. Addresses of the identified hard failed word lines are programmed into programmable address registers (e.g., fuse sets) of a fuse program circuit (such as fuse program circuit 32) to replace the hard failed word lines with redundant word lines, so that receiving an address of a hard failed word line in an attempt to activate the hard failed word line results in activation of a spare word line (and access of redundancy memory cells of the spare word line) without activating the hard failed word line. In addition, during testing of the semiconductor memory device, soft failed word lines (or soft failed memory cells, bit lines, memory cell blocks, etc.) are identified. Addresses of the identified hard soft word lines are programmed into programmable address registers (e.g., fuse sets) of a fuse program circuit (such as fuse program circuit 32) along with a soft fail indicator (such as a fuse setting to indicate a soft fail) to supplement the soft failed word lines with redundant word lines, so that receiving an address of a soft failed word line in an attempt to activate the soft failed word line results in activation of both the soft failed word line and a spare word line (and access of redundancy memory cells of the soft failed word line and the spare word line as twin cells). The soft failed word lines may be word lines with weak memory cells requiring a higher refresh rate (e.g., a smaller refresh interval) than non-defective normal memory cells. For example, any word line determined to need refreshing more than every predetermined time interval, such as more than every 64 ms, may be considered a weak memory cell row and thus a soft failed word line.

As an alternative or in addition, the soft failed word lines may be word lines identified as those word lines with the weakest memory cells, or those word lines requiring the most frequent or highest refresh rates (or smallest refresh intervals) of a group of word lines (such as a group of normal word lines sharing bit lines with a corresponding set of spare word lines). In this latter example, after identifying hard failed word lines for replacement with spare word lines, all remaining or a predetermined number of available spare word lines may be used to supplement the word lines needing the highest refresh rates. Thus, in this example, what may qualify as a weak cell and thus a soft failed word line in one memory device may not qualify as a weak cell and thus a soft failed word line in another memory device. For purposes of explanation, consider two memory devices of the same design having ten normal word lines and five spare word lines. With two of the ten normal word lines being judged hard failed in both memory devices, both memory devices are programmed to replace two hard failed normal word lines with two respective spare word lines, leaving eight operable normal word lines and three spare word lines for soft fail supplementation. During testing, it is determined that the remaining eight normal word lines of a first memory device should be refreshed at respective rates of 80 ms, 80 ms, 80 ms, 64 ms, 55 ms, 50 ms, 45 ms, and 40 ms. In this first memory device, the remaining three spare word lines are matched with the word lines needing the highest refresh rates (i.e., shortest refresh intervals of 50 ms, 45 ms, and 40 ms.). Thus, the word lines of the first memory device associated with the refresh periods of 50 ms, 45 ms and 40 ms are identified as soft failed word lines, and the programmable registers are programmed with their respective addresses so that these word lines are activated simultaneously with a corresponding spare word line to access data in twin memory cells, thus allowing an increase in their refresh rates, as described elsewhere herein. Where the supplemented soft failed word lines (i.e., those converted to twin word lines with a spare word line) have an increased refresh period of over 55 ms, this first memory device may be operated in consideration that the word lines should be refreshed every 55 ms or more frequently (corresponding to the fourth quickest refresh rate of the word lines after testing before supplementing with spare word lines).

Considering the second memory device in this example, during testing, it is determined that the eight normal word lines of the second memory device should be refreshed at respective rates of every 80 ms, 80 ms, 80 ms, 64 ms, 64 ms, 55 ms, 40 ms, and 40 ms. For this second memory device, the word lines associated with the refresh intervals of 55 ms, 40 ms and 40 ms are identified as soft failed word lines, and the programmable registers are programmed with their respective addresses so that these word lines are activated simultaneously with a corresponding spare word line to access data in twin memory cells, thus allowing an increase in their refresh rates, as described elsewhere herein. Unlike the word line of the first memory device corresponding to the refresh interval of 55 ms, in the second memory device, the word line associated with the refresh interval of 55 ms is considered a soft fail because there is an available spare word line to supplement its operation (after supplementing normal word lines having higher refresh rate requirements). Thus, the available spare word line allows increasing the refresh period of this word line, and thus, in this example, the entire second memory device refresh rate is improved. This second memory device may be operated at a refresh rate of 64 ms. If additional spare word lines were available, additional normal word lines may be supplemented. In this example, if the second memory device did not have any hard failed word lines, two additional spare word lines may be used to supplement the word lines associated with the tested refresh interval, which may allow increase the refresh interval for the entire device to 80 ms. As noted, this is a simplified example. In many devices, the use of available spare word lines may be limited to use with normal word lines sharing the same bit lines with the spare word lines and/or to non-defective spare word lines and/or not-defective spare word lines having a predetermined refresh interval or higher.

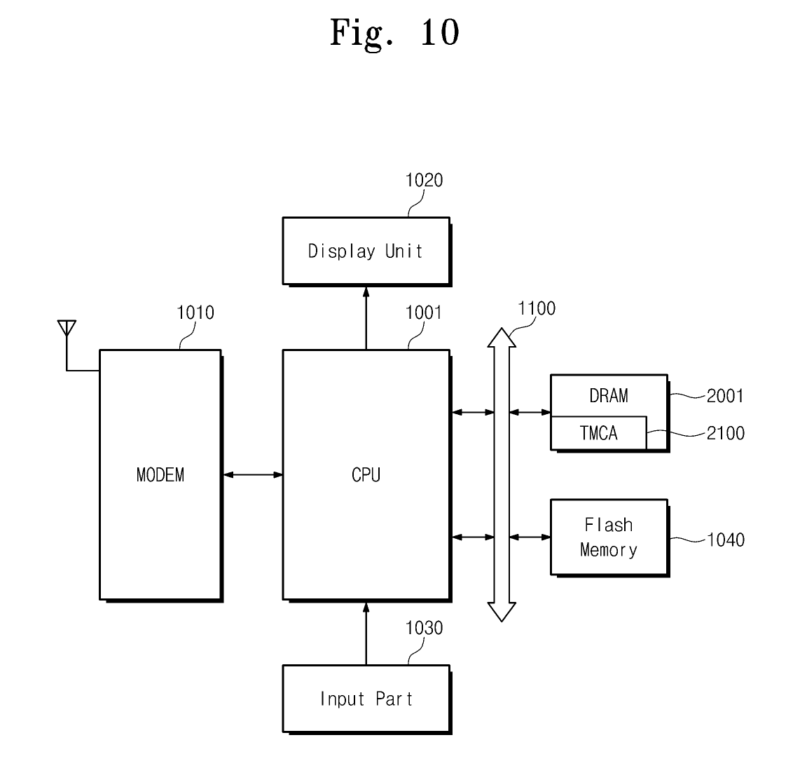

FIG. 10 is a block diagram illustrating an application of the inventive concept embedded at an electronic device.

Referring to FIG. 10, an electronic device may include a modem 1010, a CPU 1001, a DRAM 2001, a flash memory 1040, a display unit 1020, and an input part 1030.

The constituent elements 1001, 2001, and 1040 may be integrated in a chip or packed. That is, the DRAM 2001 and the flash memory 1040 may be embedded at the electronic device.

In the event that the electronic device is a portable communication device, the modem 1010 may be configured to modulate and demodulate communication data.

The CPU 1001 may control an overall operation of the electronic device according to a predetermined program.

The DRAM 2001 may be connected with the CPU 1001 through a system bus 1100, and may be used as a main memory of the CPU 1001. The DRAM 2001 may be configured such that a twin memory cell array 2100 including twin cells according to an embodiment of the inventive concept is provided within a memory cell array. The CPU 1001 may provide command signals, address signals, and data to the DRAM 2001 through the system bus 1100. The DRAM 2001 may decode the command signals to perform a refresh operation for maintaining data stored at memory cells.

A normal memory cell or normal memory cells judged to be soft failed at a test level may not be replaced with a redundancy memory cell or redundancy memory cells. Instead, a weak cell having a defect such as soft fail may be configured to be operated as a twin cell with a redundancy memory cell. Since the repair efficiency and yield are improved without lowering of the operation reliability of the DRAM 2001, a fabrication cost of the electronic device may be lowered.

The flash memory 1040 may be a NOR-type or NAND-type flash memory.

The display unit 1020 may include a liquid crystal having a backlight, a liquid crystal having an LED light source, or a touch screen as an OLED element. The display unit 1020 may be used as an output element displaying color images such as characters, numbers, pictures, and the like.

The input part 1030 may be an input element including a number key, a function key, and the like, and may provide an interface between the electronic device and a user.

The electronic device is described on a mobile communication device basis. However, in case of need, the electronic device may be used as a smart card by adding or removing elements.

The electronic device may be connected with an external communication device through a separate interface. The communication device may be a DVD player, a computer, a set top box (STB), a game machine, a digital camcorder, and the like.

Although not shown in FIG. 10, the electronic device may further include an application chipset, a camera image processor (CIS), a mobile DRAM, and the like.

The DRAM chip or the flash memory chip may be independently or simultaneously packed by various types of packages such as PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), and the like.

In FIG. 10, there is described an example that the electronic device includes a flash memory. However, the electronic device can be configured to include nonvolatile storage.

The nonvolatile storage may store various types of data information such as text, graphic, software code, and the like.

The nonvolatile storage may, for example, include Electrically Erasable Programmable Read-Only Memory (EEPROM), flash memory, magnetic RAM (MRAM), Spin-Transfer Torque MRAM, Conductive bridging RAM (CBRAM), ferroelectric RAM (FeRAM), phase change RAM (PRAM) called OUM (Ovonic Unified Memory), resistive RAM (RRAM or ReRAM), Nanotube RRAM, polymer RAM (PoRAM), Nano Floating Gate Memory (NFGM), holographic memory, molecular electronics memory device, or insulator resistance change memory.

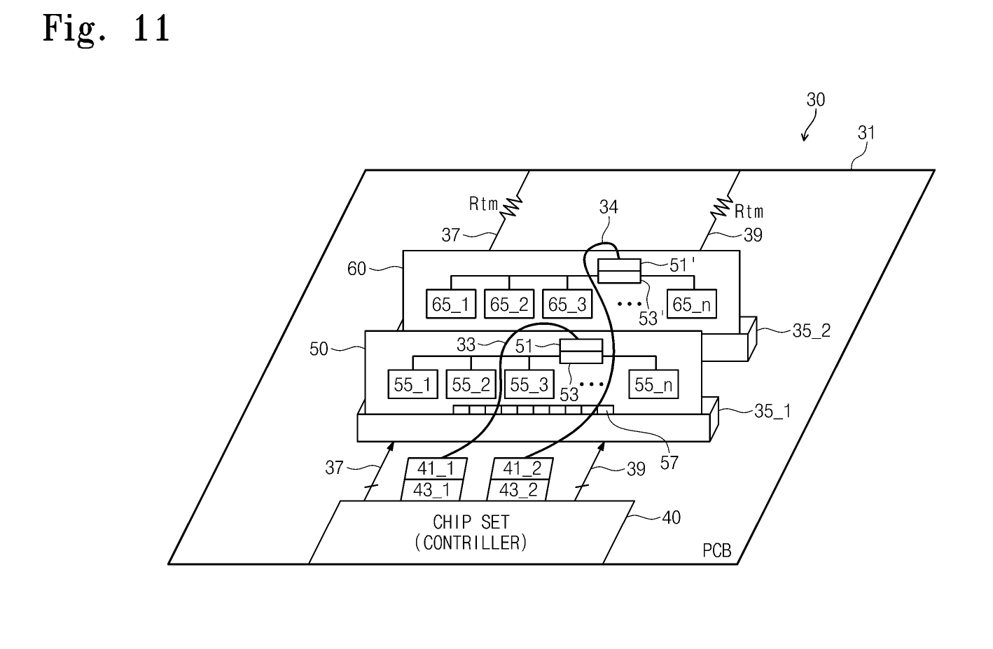

FIG. 11 is a block diagram illustrating an application of the inventive concept applied to an optical I/O scheme. Referring to FIG. 11, a memory system 30 adopting high-speed optical I/O may include a chipset 40 as a controller and memory modules 50 and 60 mounted on a PCB substrate 31. The memory modules 50 and 60 may be inserted in slots 35_1 and 35_2 installed on the PCB substrate 31, respectively. The memory module 50 may include a connector 57, memory chips 55_1 to 55_n, an optical I/O input part 51, and an optical I/O output part 53.

The optical I/O input part 51 may include a photoelectric transformation element (e.g., photodiode) for converting an input optical signal into an electrical signal. An electrical signal output from the photoelectric transformation element may be provided to the memory module 50. The optical I/O output part 53 may include an electric-photo transformation element (e.g., laser diode) for converting an electrical signal output from the memory module 50 into an optical signal. In case of need, the optical I/O output part 53 may further include an optical modulator for modulating a signal output from a light source.

An optical cable 33 may perform an optical communication between the optical I/O input part 51 and an optical transfer part 41_1 of the chipset 40. The optical communication may have a bandwidth over tens of gigabytes per second. The memory module 50 may receive signals or data applied from signal lines 37 and 39 of the chipset 40 through the connector 57, and may perform a high-speed data communication with the chipset 40 through the optical cable 33. Resistors Rtm installed at lines 37 and 39 may be termination resistors.

A twin cell operating scheme may be applied to a memory system adopting an optical I/O structure in FIG. 11. As a result, memories in the memory modules 50 and 60 may be configured to operate a weak cell and a redundancy memory cell as a twin cell without replacing the weak cell.

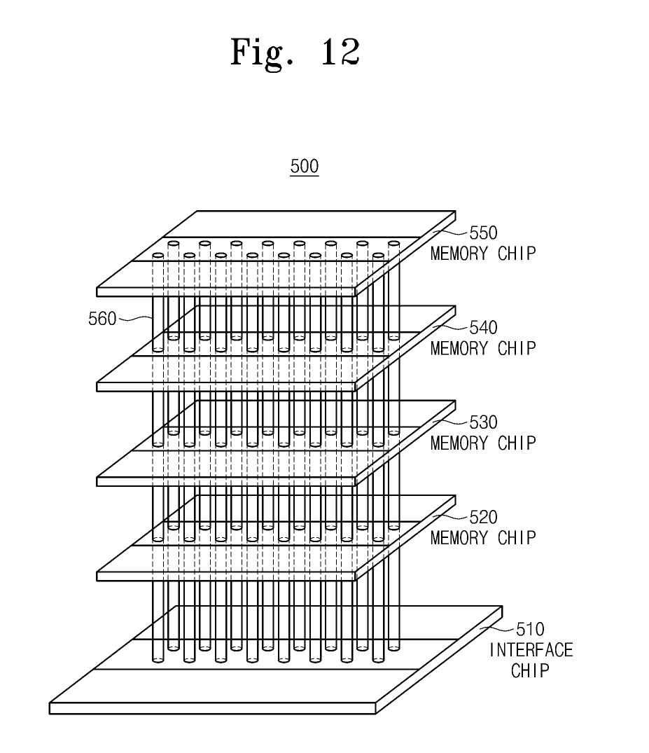

FIG. 12 is a block diagram illustrating an application of the inventive concept applied to a through silicon via (TSV) structure.

Referring to a stack type memory device 500 in FIG. 12, a plurality of memory chips 520, 530, 540, and 550 may be vertically stacked on an interface chip 510. Herein, a plurality of through silicon vias 560 may be formed to penetrate the memory chips 520, 530, 540, and 550. A three-dimensional stack package type memory device 500 formed by vertically stacking the plurality of memory chips 520, 530, 540, and 550 on the interface chip 510 using the TSV technique may store mass data, and may be advantageous for high speed, low power, and small size.

In case of the stack type memory device in FIG. 12, memories in the memory chips 520, 530, 540, and 550 may be configured to operate a weak cell and a redundancy memory cell as a twin cell without replacing the weak cell.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A semiconductor memory device, comprising:
a normal memory cell array;
a redundancy memory cell array; and
a multi-row selection part configured to activate a defective normal memory cell or a defective normal word line of the normal memory cell array together with a redundancy memory cell or a redundancy word line of the redundancy memory cell array.

2. The semiconductor memory device of claim 1, wherein a defect state of the defective normal memory cell or the defective normal word line is a soft fail state.

3. The semiconductor memory device of claim 2, wherein when the defective normal memory cell or the defective normal word line has a hard fail state, the multi-row selection part activates the redundancy memory cell or the redundancy word line, independently.

4. The semiconductor memory device of claim 1, wherein the defective normal memory cell and the redundancy memory cell operate as a twin cell.

5. The semiconductor memory device of claim 1, wherein the defective normal word line and the redundancy word line are used as a twin word line.

6. The semiconductor memory device of claim 1, wherein the multi-row selection part comprises:
a normal word line selection circuit configured to inactivate a normal word line of the normal memory cell array in response to a normal word line blocking signal applied when the defective normal memory cell or defective normal word line is programmed as hard fail; and
a redundancy word line selection circuit configured to display the normal word line blocking signal when the defective normal memory cell or the defective normal word line is programmed as soft fail and to activate a redundancy word line of the redundancy memory cell array.

7. A semiconductor memory device, comprising:
a memory cell array including a plurality of memory blocks each having a plurality of normal memory cells connected with a plurality of normal word lines and a plurality of redundant memory cells connected with a plurality of redundant word lines; and
a multi-row selection circuit configured to, in response to a first address, simultaneously activate both a first defective normal word line in a first memory block and a first redundant word line in the first memory block, memory cells of the first defective normal word line and the first redundant word line being paired as twin memory cells, wherein the first defective normal word line is connected to one or more weak memory cells.

8. The semiconductor memory device of claim 7, wherein normal memory cells of the memory cell array that are not weak memory cells are characterized by an ability to retain data for a longer period of time than the one or more weak memory cells.

9. The semiconductor memory device of claim 8, wherein the multi-row selection circuit is configured to, in response to a second address, activate a second defective redundant word line and prevent activation of a second normal word line identified by the second address.

10. The semiconductor memory device of claim 7, wherein the first defective normal word line and the first redundant word line form a twin word line have a longer minimum refresh interval than a minimum refresh interval of the first defective normal word line.

11. The semiconductor memory device of claim 7, wherein the first defective normal word line and the first redundant word line function as a twin word line having an improved memory operation property as compared to the first defect normal word line.

12. The semiconductor memory device of claim 7, wherein the multi-row selection circuit comprises:
a normal word line selection circuit configured to not activate an addressed normal word line of the normal memory cell array in response to a normal word line blocking signal having a first logic state; and
a redundancy word line selection circuit configured to transmit the first logic state of the normal word line blocking signal to the normal word line selection circuit in response to identifying the addressed normal word line as a hard fail defective word line, and configured to not transmit the first logic state of the normal word line blocking signal in response to identifying the addressed normal word line as a soft fail word line.

13. The semiconductor memory device of claim 12, wherein the normal word line selection circuit comprises:
a normal row decoder configured to decode a row address to generate a decoded row address; and
a normal word line driver configured to drive a selected normal word line in response to the decoded row address and the normal word line blocking signal.

14. The semiconductor memory device of claim 13, wherein the redundancy word line selection circuit comprises:
a fuse program circuit configured to store addresses associated with hard failed and soft failed normal memory cells or normal word lines and to output a redundancy signal when an input address is equal to one of the stored addresses;
a blocking selection part configured to transmit the normal word line blocking signal in response to the redundancy signal and to not transmit the normal word line block signal when an address indicating a soft failed normal word line or normal word line is received; and
a redundancy word line driver configured to drive a redundancy word line in response to the redundancy signal.

15. The semiconductor memory device of claim 14, wherein the defective normal memory cell and the redundancy memory cell form a twin cell connected with a bit line and a complementary bit line.

16. A method of manufacturing, comprising:
testing a semiconductor memory device to determine defective memory cells;
programming the semiconductor memory device to replace one or more first defective normal memory cells with one or more first redundant memory cells such that addressing the one or more first defective normal memory cells for access results in accessing the first redundant memory cells; and
programming the semiconductor memory device to supplement one or more second normal memory cells with one or more second redundant memory cells such that addressing the one or more second normal memory cells for access results in simultaneously accessing the one or more second normal memory cells and the one or more second redundant memory cells.

17. The method of claim 16, further comprising:
testing the semiconductor memory device to determine weak memory cells of the semiconductor memory device;
wherein the second normal memory cells are weak memory cells a determined by the testing step.

18. The method of claim 17, further comprising determining weak memory cells as memory cells requiring a refresh rate higher than a predetermined value.

19. The method of claim 18,
wherein the one or more first defective normal memory cells are connected to a first normal word line,
wherein the first one or more redundant memory cells are connected to a first redundant word line,
wherein the one or more second normal memory cells are connected to a second normal word line,
wherein the one or more second redundant memory cells are connected to a second redundant word line, and
wherein the first normal word line and the first redundant word line are connected to the same bit lines.

20. The method of claim 19, wherein the first normal word line, the first redundant word line, the second normal word line and the second redundant word line are connected to the same bit lines.
